(19) United States
(12) Patent Application Publication
(10) Pub. No.: US 2026/0122717 A1
(43) Pub. Date: Apr. 30, 2026

(54) OPERATING MODE REQUEST FOR MULTI-AP IN WIRELESS LOCAL AREA NETWORKS

(71) Applicant: Samsung Electronics Co., Ltd., Gyeonggi-do (KR)

(72) Inventors: Yongsen MA, Milpitas, CA (US); Michail KOUNDOURAKIS, Hamburg (DE); Mark Gorthorn RISON, Cambridge (GB); Srinivas KANDALA, Morgan Hill, CA (US); Ravi GIDVANI, Fremont, CA (US)

(21) Appl. No.: 19/371,860

(22) Filed: Oct. 28, 2025

Related U.S. Application Data
(60) Provisional application No. 63/712,833, filed on Oct. 28, 2024.

(51) Int. Cl. H04W 76/20; H04L 1/1607

(52) U.S. Cl. CPC H04W 76/20; H04L 1/1607

(57) ABSTRACT

A system and a method are disclosed to improve performance between Access Points (APs), for example belonging to a same wireless network. The method comprises sending, by an initiating AP to a responding AP, an operating mode request (OMR) to change an operating mode or parameter of the responding AP; and receiving, by the initiating AP from the responding AP, a response to the OMR, wherein the response comprises: an acknowledgement of changing the operating mode or parameter, or a refusal response. The operating mode or parameter can comprise an Ultra High Reliability (UHR), pre-UHR, or post-UHR operating mode or parameter, and/or a single-AP operating mode or parameter or a multi-AP coordination (MAPC) operating mode or parameter.

### CROSS-REFERENCE TO RELATED APPLICATION

This application claims the priority benefit under 35 U.S.C. § 119(e) of U.S. Provisional Application No. 63/712,833, filed on Oct. 28, 2024, the disclosure of which is incorporated by reference in its entirety as if fully set forth herein.

### TECHNICAL FIELD

The disclosure generally relates to wireless networking. More particularly, the subject matter disclosed herein relates to improvements to wireless networking performance within a multi-Access Point (AP) setting.

### SUMMARY

A wireless network, such as a wireless local area network (WLAN) or Wi-Fi network, may make use of multiple APs in order to provide greater coverage of the wireless signal, for example throughout multiple rooms or on multiple floors of a structure. However, in such a multi-AP/basic service set (BSS) setting, the operating modes or parameters of one AP or BSS may affect the performance of nearby APs or BSSs. Accordingly, such a scenario can potentially result in interference among the signals of the different APs. For example, if two nearby APs have overlapping of operating bandwidth or transmit opportunity (TXOP), there may be increased interference and reduced performance for the APs and associated stations (STAs).

An STA of the wireless network may change its operating mode (such as bandwidth (BW), number of spatial streams (NSS), or the like) and notify other STAs via different mechanisms, for example, an operating mode notification (OMN; in management/action frame) or operating mode indication (OMI; in aggregated control (A-Control) field). However, such mechanisms can be used for notification and/or indication purposes, but not for requests, negotiation, or coordination of specific operating modes among STAs. In addition, mechanisms such as OMN and OMI can be used between an AP and associated non-AP STAs, but cannot be used between two or more APs. Finally, prior to 802.11bn Ultra High Reliability (UHR; e.g., Wi-Fi 8), APs cannot coordinate with one another about their respective operating modes or parameters.

To overcome these types of issues, systems and methods are described herein for improving wireless network performance in multi-AP settings by providing coordination among multiple APs. In particular, the disclosed systems and methods provide a framework to enable APs to request to update certain operating modes and/or parameters. According to embodiments, various STAs (e.g., AP to AP, AP to non-AP STA, non-AP STA to AP, and/or non-AP STA to non-AP STA) can negotiate via an operating mode request (OMR), whereby a respective STA may request another STA to run in a certain operating mode. The present disclosure provides additional features of such an OMR for multi-AP (e.g., AP to AP) coordination (e.g., inter-BSS/extended service set (ESS)/vendor/admin) in multi-AP settings. For example, according to embodiments, the APs can exchange an OMR to change one or more operating mode or parameter, thereby reducing interference and improving performance.

In an embodiment, a method to improve performance between Access Points (APs) (for example, belonging to a same wireless network) comprises sending, by an initiating AP to a responding AP, an OMR to change an operating mode or parameter of the responding AP; and receiving, by the initiating AP from the responding AP, a response to the OMR, wherein the response comprises: an acknowledgement of changing the operating mode or parameter, or a refusal response. The operating mode or parameter can comprise a pre-UHR, UHR, or post-UHR operating mode or parameter.

In an embodiment, a method implemented by a responding AP comprises receiving, from an initiating AP, an OMR to change an operating mode or parameter of the responding AP; determining whether to accept or refuse the OMR; responsive to determining to accept the OMR: changing the operating mode or parameter; and sending, to the initiating AP, a response to the OMR comprising an acknowledgement of the changing the operating mode or parameter; and responsive to determining to refuse the OMR, sending a refusal response to the initiating AP.

In an embodiment, an initiating AP comprises: a wireless transceiver; and a processor configured to: transmit, via the wireless transceiver and to a responding AP, an OMR to change an operating mode or parameter of the responding AP; and receive, from the responding AP, a response to the OMR, wherein the response comprises: an acknowledgement of changing the operating mode or parameter, or a refusal response.

In an embodiment, the operating mode or parameter comprises a pre-Ultra High Reliability (pre-UHR) operating mode or parameter, the pre-UHR operating mode or parameter comprising one or more of: a primary channel location, a bandwidth (BW), transmit (TX) power, or Spatial Reuse Parameter Set values. In another embodiment, the operating mode or parameter comprises an Ultra High Reliability (UHR) operating mode or parameter, wherein the UHR operating mode or parameter comprises: a single-AP operating mode or parameter, comprising one or more of: AP power save, non-primary channel access (NPCA), Dynamic Sub-band Operation (DSO), preemption operations, or low latency operations; or a multi-AP coordination (MAPC) operating mode or parameter, comprising one or more of: coordinated spatial reuse (co-SR), coordinated beamforming (co-BF), Coordinated Time Division Multiple Access (Co-TDMA), Coordinated Restricted Target Wake Time (Co-RTWT), a multi-AP coordination scheme, or a common framework for multi-AP coordination procedures. In another embodiment, the operating mode or parameter comprises a post-UHR operating mode or parameter to be defined in future generations of IEEE 802.11/Wi-Fi.

### BRIEF DESCRIPTION OF THE DRAWING

In the following section, the aspects of the subject matter disclosed herein will be described with reference to exemplary embodiments illustrated in the figures, in which:

FIG. 1 illustrates a wireless network with multiple APs, potentially resulting in interference among the APs.

FIG. 2 illustrates a wireless network with multiple APs having different operating modes or parameters, as negotiated via an OMR, according to an embodiment, thereby improving performance among the multiple APs.

FIG. 3A illustrates an example OMR format, according to an embodiment.

FIG. 3B illustrates an example OMR format for existing (e.g., pre-UHR) operating mode parameters, according to an embodiment.

FIG. 3C illustrates an example OMR format for new (e.g., UHR or post-UHR) operating mode parameters, according to an embodiment.

FIG. 3D illustrates an example OMR format for multi-AP coordination (e.g., UHR or post-UHR) operating mode parameters, according to an embodiment.

FIG. 4A is a communication flow diagram illustrating a method to improve performance between APs, according to an embodiment.

FIG. 4B is a communication flow diagram illustrating a method to improve performance between APs, according to an embodiment.

FIG. 5 is a flow diagram illustrating a method to improve performance between APs, according to an embodiment.

FIG. 6 is a block diagram of an electronic device in a network environment, according to an embodiment.

FIG. 7 shows a system including a STA and an AP in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

A wireless network, such as a WLAN or Wi-Fi network, may make use of multiple APs in order to provide greater coverage of the wireless signal, for example throughout multiple rooms or on multiple floors of a structure. However, in such a multi-AP/BSS setting, the operating modes or parameters of one AP or BSS may affect the performance of nearby APs or BSSs. Accordingly, such a scenario can potentially result in interference among the signals of the different APs. For example, if two nearby APs have overlapping of operating bandwidth or TXOP, there may be increased interference and reduced performance for the APs and associated STAs.

An STA of the wireless network may change its operating mode (such as BW, NSS, or the like) and notify other STAs via different mechanisms, for example, an operating mode notification (OMN; in management/action frame) or operating mode indication (OMI; in A-Control field). However, such mechanisms can be used for notification and/or indication purposes, but not for requests, negotiation, or coordination of specific operating modes among STAs. In addition, mechanisms such as OMN and OMI can be used between an AP and associated non-AP STAs, but cannot be used between two or more APs. Finally, prior to 802.11bn UHR (e.g., Wi-Fi 8), APs cannot coordinate with one another about their respective operating modes or parameters.

The disclosed systems and methods can address these issues by providing coordination among multiple APs, thereby improving wireless network performance in multi-AP settings. In particular, the disclosed systems and methods provide a framework to enable a respective AP to request another AP to update certain operating modes and/or parameters, including pre-UHR (up to Wi-Fi 7), UHR (Wi-Fi 8), and post-UHR (Wi-Fi 9 and beyond) operating modes and/or parameters. According to embodiments, various STAs can negotiate via an OMR, whereby a respective STA may request another STA to run in a certain operating mode.

The present disclosure provides additional features of such an OMR for multi-AP (e.g., AP to AP) coordination (e.g., inter-BSS/ESS/vendor/admin) in multi-AP settings. Thus, according to embodiments, an initiating AP may request or recommend a responding AP to change its operating mode, for example to change BW or primary channel selection so as to reduce or avoid interference on primary or non-primary channels or for other coordination purposes.

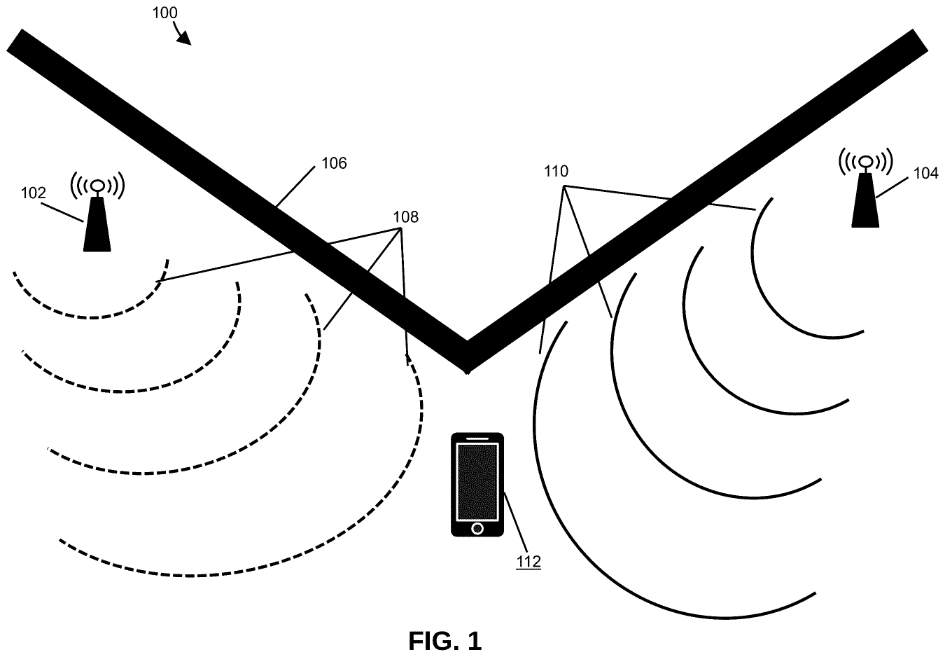

FIG. 1 illustrates a wireless network 100 with multiple APs, potentially resulting in interference among the APs. For example, the wireless network 100 can be a WLAN such as a Wi-Fi network.

Referring to FIG. 1, the wireless network 100 can be a multi-AP setting, including at least two APs 102 and 104, and a non-AP STA 112. In an example, the APs 102 and 104 may be partially separated from one another by a wall 106, which may partially block their respective wireless signals 108 and 110. For example, the signal 108 from AP 102 may be prevented by wall 106 from reaching the vicinity of AP 104, while the signal 110 from AP 104 may be prevented by wall 106 from reaching the vicinity of AP 102. Accordingly, in order to cover all areas, APs 102 and 104 may both be provided, and may both be in use within the same wireless network 100.

However, in this example, the wall 106 does not entirely separate APs 102 and 104, and some locations, such as the corner in wall 106, may be reachable by both signals 108 and 110. For example, as shown, non-AP STA 112 may be at least partially exposed to both signals 108 and 110 from APs 102 and 104, respectively. In this case, signals 108 and 110 may interfere, leading to sub-optimal performance of the wireless network 100. For example, interference between signals 108 and 110 may result in garbled or inconsistent signals reaching non-AP STA 112.

Embodiments of the disclosed system and methods can address these issues by providing negotiation among multiple APs, thereby improving wireless network performance in multi-AP settings, as described herein.

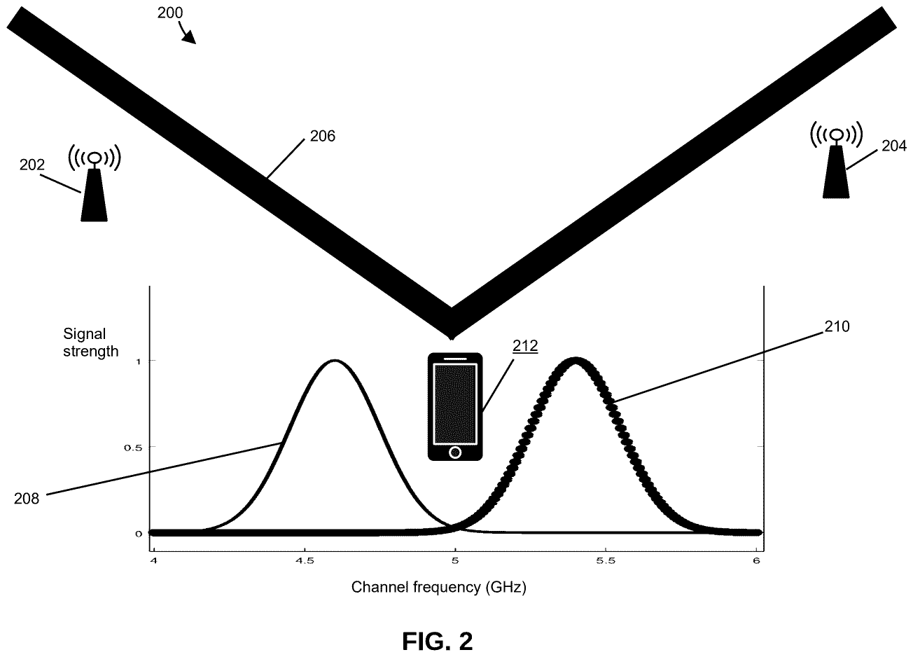

As in the example of FIG. 1, certain operating mode parameters may affect neighboring APs and/or OBSS. According to embodiments, such operating mode parameters can be coordinated among APs so as to improve inter-AP or OBSS performance, for example, to avoid interference and improve coexistence. For example, AP 202 can request that AP 204 change its primary channel location and/or BW, so as to reduce interference and thereby improve performance, as in the example of FIG. 2 below. In another example, AP 202 may request AP 204 to change its TX power, so as to reduce or increase its range, for example to reduce interference. In a third example, AP 202 can request AP 204 to change its Spatial Reuse Parameter Set values, so as to reduce or increase sensitivity, or to enable, disable, and/or update spatial reuse modes.

FIG. 2 illustrates a wireless network 200 with multiple APs having different operating modes or parameters, as negotiated via an OMR, according to an embodiment, thereby improving performance among the multiple APs. For example, the wireless network 200 can be a WLAN such as a Wi-Fi network.

Referring to FIG. 2, in an example, the wireless network 200 can include APs 202 and 204, a wall 206, and a non-AP STA 212, similar to the wireless network 100 of FIG. 1. However, unlike in wireless network 100, according to embodiments the APs 202 and 204 of wireless network 200 can coordinate, so as to improve multi-AP performance and reduce interference.

For example, as illustrated in FIG. 2, the APs 202 and 204 can coordinate to use different primary channel locations for their wireless (e.g., radio) communications with the wireless network 200. In this example, the AP 202 can use the spectrum 208 with a center frequency at approximately 4.6 GHz and the AP 204 can use the spectrum 210 with a center frequency at 5.4 GHz, thus the APs 202 and 204 are illustrated using different primary channel locations. Moreover, as shown, the two center frequencies have a separation that is large compared to their BWs, so there is little likelihood of interference between the APs'signals.

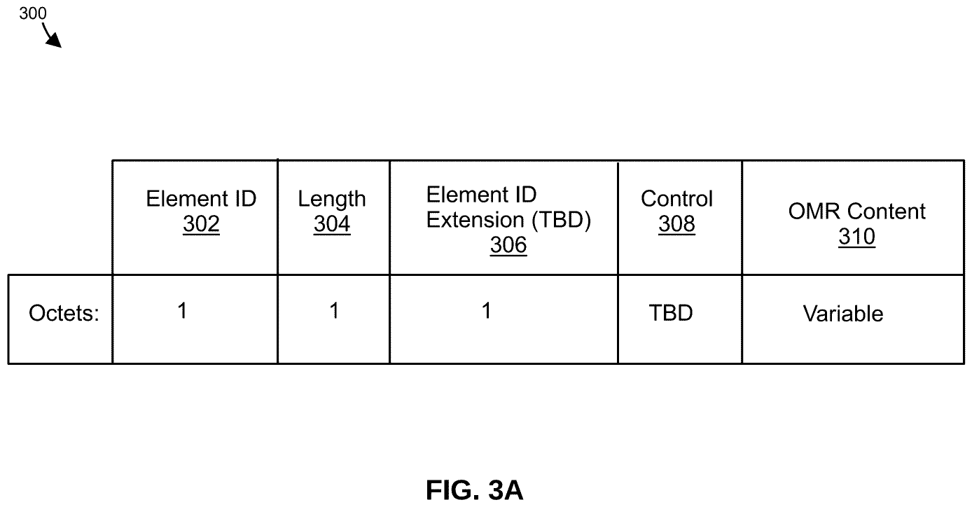

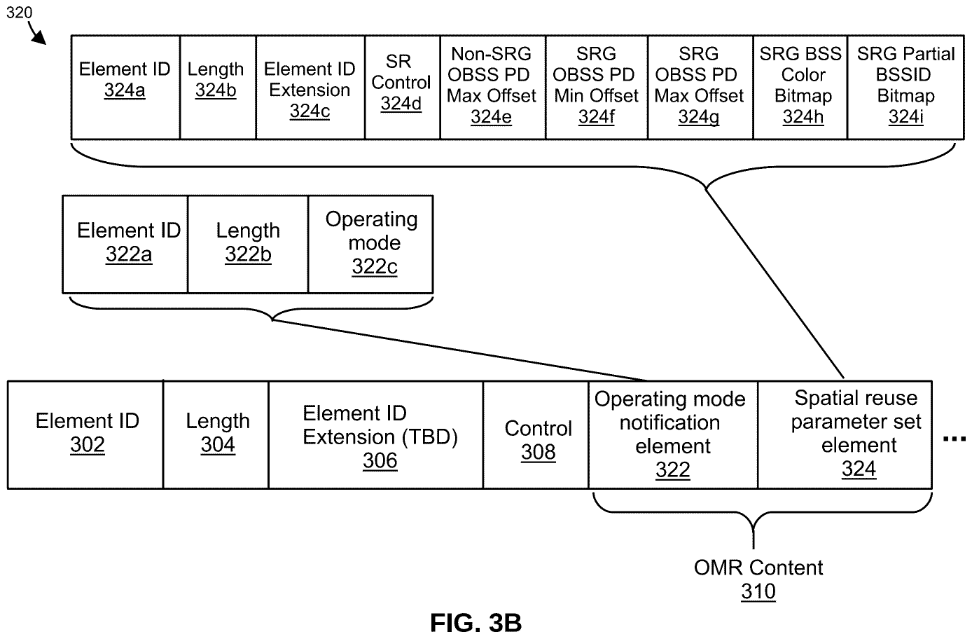

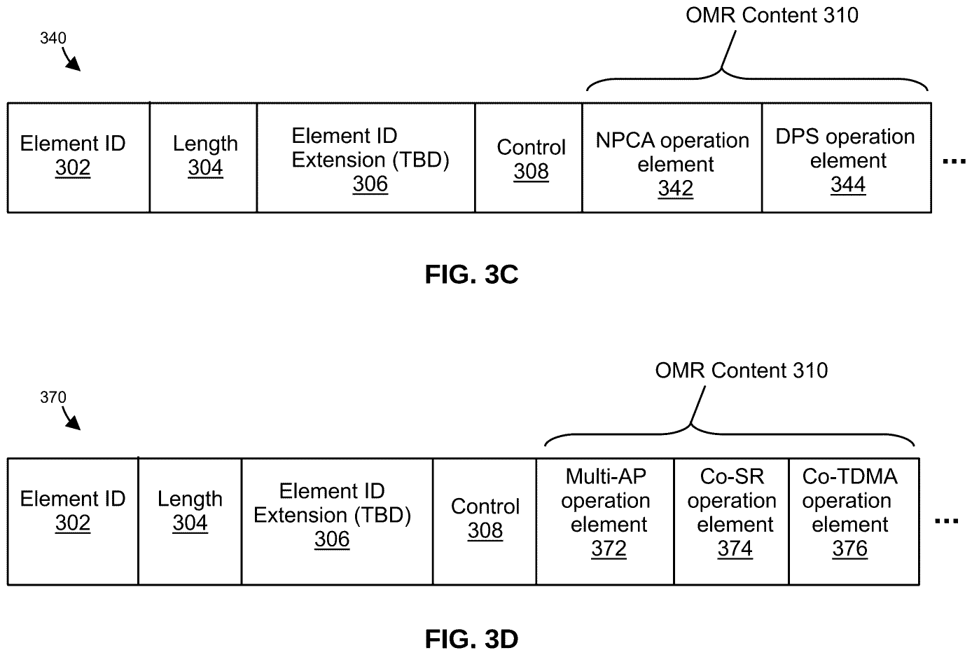

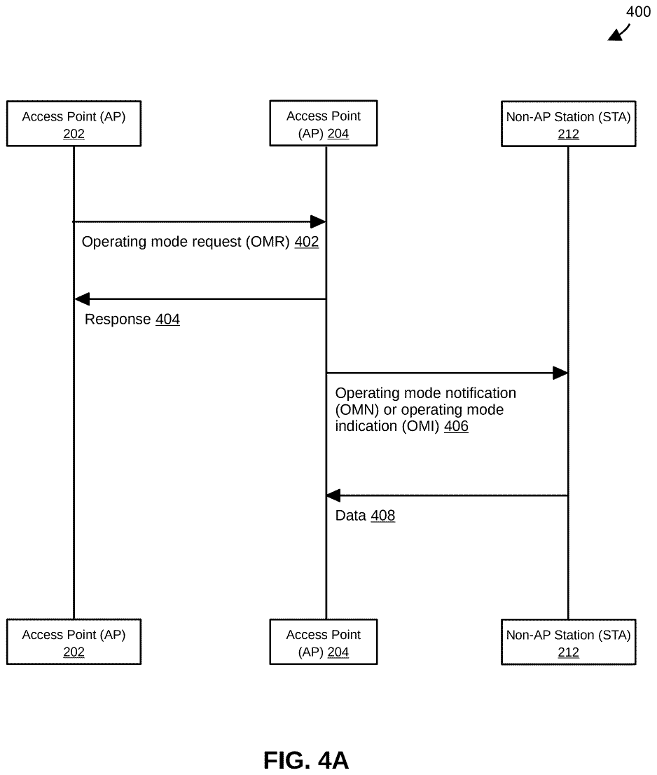

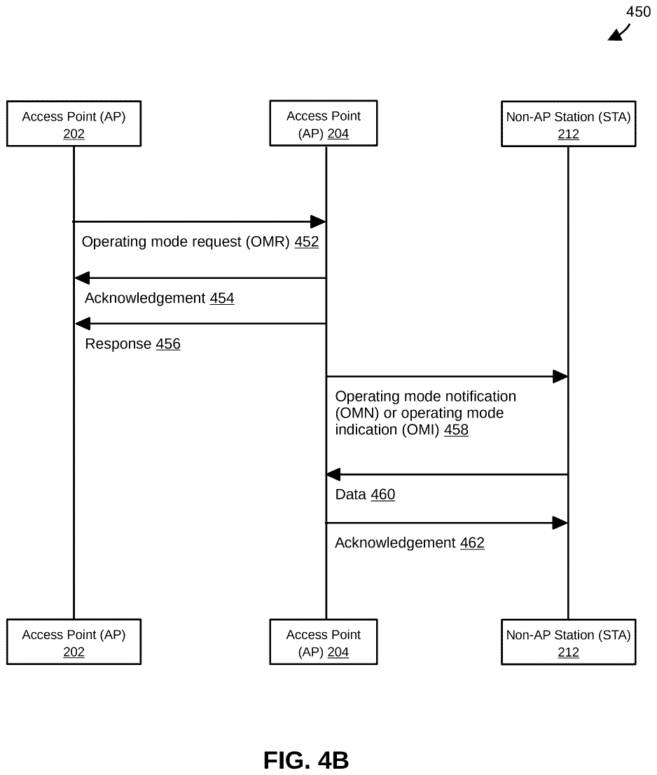

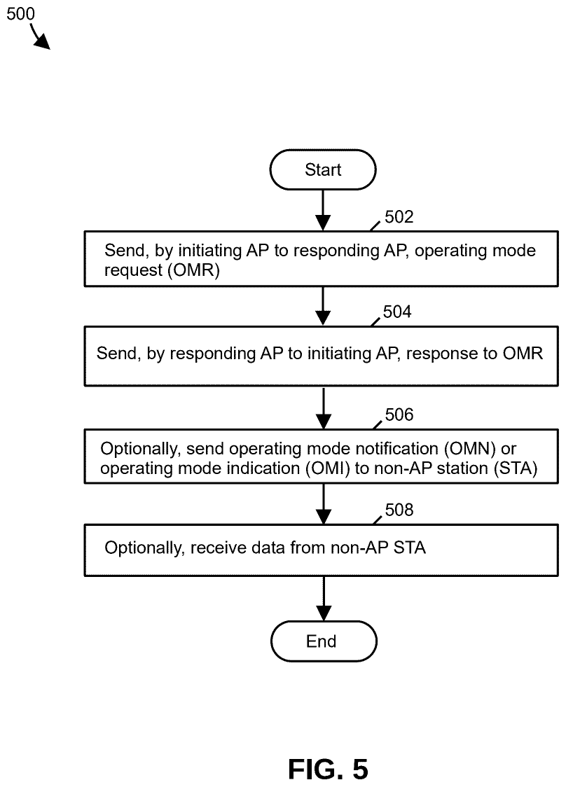

Accordingly, in this example, both APs 202 and 204 can operate simultaneously within the same wireless network 200, and with improved performance. Although APs 202 and 204 are situated around a corner of wall 206 from each other, they are still both close enough to non-AP STA 212 so as to potentially interfere, as in the example of FIG. 1. However, as disclosed herein, APs 202 and 204 can coordinate in order to change one or more operating mode or parameter, such as the primary channel location. For example, AP 202 may send AP 204 a request (e.g., an OMR) to change one or more operating mode or parameter, as described in greater detail below in the examples of FIGS. 4A-4B and 5. In various examples, the operating mode or parameter may include a pre-UHR, UHR, or post-UHR operating mode or parameter, such as a primary channel location, a bandwidth, transmit (TX) power, Spatial Reuse (SR) Parameter Set values, AP power save, non-primary channel access (NPCA), Dynamic Sub-band Operation (DSO), preemption and/or low latency operations, a coordinated spatial reuse (co-SR), coordinated beamforming (co-BF), Coordinated Time Division Multiple Access (Co-TDMA), Coordinated Restricted Target Wake Time (Co-RTWT), a multi-AP coordination (MAPC) scheme, or a common framework for multi-AP coordination procedures, as described in greater detail in the examples of FIGS. 3A-3D.

While FIG. 2 illustrates two APs 202 and 204 and one non-AP STA 212, in various embodiments, the wireless network 200 may include any number of APs and/or non-AP STAs, and is not limited by the present disclosure.

FIG. 3A illustrates an example OMR format 300, according to an embodiment. The present disclosure presents additional features of an OMR for multi-AP settings. In some examples, certain operating mode parameters may affect neighboring APs and/or OBSS. Such operating mode parameters can be adjusted to improve inter-AP or OBSS performance, for example, to avoid interference and improve coexistence.

The OMR 300 may include different request types, such as recommending a change or requiring a certain operating mode. In an example, the OMR 300 may include an indication for a request, for example a reason code, such as channel planning, coordinated spatial reuse, latency sensitive traffic, or the like.

Referring to FIG. 3A, the OMR format 300 includes element ID field 302, a length field 304, an element ID extension field 306, a control field 308, and an OMR content field 310. An OMR may be solicited or unsolicited, with or without a requirement of a response frame. As illustrated, the element ID field 302, length field 304, and element ID extension field 306 may each store 1 octet of information, whereas the OMR content field 310 may have a variable size. The control field 308 may have a size that varies in various embodiments, for example so as to accommodate future extensions to the OMR format 300. Likewise, the contents of the element ID extension field 306 may vary in various embodiments, so as to accommodate future extensions to the OMR format 300.

For example, the control field 308 of the OMR format 300 may include control information, such as a request type, a mode, an identifier (ID), a token, or the like. The OMR content field 310 may include content information. The content information may include certain existing or new information elements/fields such as an OMN element or a multi-AP operation element. Alternatively or additionally, the content information may include an operating mode parameter (e.g., certain existing or new operating mode parameters) based on the control field. In some examples, the OMR content field 310 may include the main content of the OMR, such as a specification of one or more operating mode or parameter, and/or values to which the one or more operating mode or parameter should be changed.

An acknowledgement response (e.g., ACK) received by an initiating STA after the frame containing the OMR 300 may confirm that the OMR 300 was received by the responding AP. A response to OMR 300 by a responding AP, i.e., an operating mode response, may indicate whether the responding AP accepts or refuses OMR 300.

An ACK and an operating mode response may provide options for explicit and implicit indications. For example, if the OMR 300 is acknowledged, i.e., the initiating AP receives an ACK after transmitting OMR 300, but the responding AP does not send an OMI, an OMN, or any other related response frames, then the initiating AP may understand that the responding AP has received and rejected the OMR 300. However, if the responding AP decides to accept OMR 300, it may send an OMI or initiate an OMN procedure with the requested updated operating mode (or other mechanisms such as notify channel width and high throughput (HT), very HT (VHT), high efficiency (HE), extremely high throughput (EHT), ultra high reliability (UHR), or future generation operation elements).

The disclosed OMR 300 and/or response may rely on AP-to-AP communication. However, the disclosed embodiments may rely on another AP-to-AP communication framework. For example, the disclosed embodiments can reuse, or be part of, the AP-to-AP framework and/or the agreement negotiation procedure defined in the common framework for multi-AP coordination procedures.

In various embodiments, details and rules for how and when to utilize the OMR 300 may vary. For example, in various embodiments an OMR can be sent between controller and/or controlled APs in controlled or centralized scenarios where APs are managed by one or more central controller, or from distributed and/or uncontrolled APs in uncontrolled or distributed scenarios where APs operate independently without a central manager. For example, an OMR may be transmitted from a controller AP to a controlled AP over the air. A controller AP may possess more information and have greater ability to control other APs. OMRs can also be transmitted from a controller AP to another controller AP, from a controlled AP to another controlled AP, from a controlled AP to a controller AP, and/or between distributed or uncontrolled APs.

FIG. 3B illustrates an example OMR format 320 for existing (e.g., pre-UHR) operating mode parameters, according to an embodiment. For example, an initiating AP (e.g., AP 202 of the examples of FIG. 2 above and FIGS. 4A-4B below) can request that a responding AP (e.g., AP 204 of the examples of FIGS. 2 and 4A-4B) change existing (e.g., pre-UHR) operating mode parameters such as the responding AP's primary channel location and/or BW, so as to reduce interference and thereby improve performance. In another example, the initiating AP may request the responding AP to change existing operating mode parameters such as the responding AP's TX power, so as to reduce or increase its range, for example to reduce interference. In a third example, the initiating AP can request the responding AP to change existing parameters such as the responding AP's Spatial Reuse Parameter Set values, so as to reduce or increase sensitivity, or to enable, disable, and/or update spatial reuse modes.

Referring to FIG. 3B, the OMR format 320 for existing (e.g., pre-UHR) operating mode parameters can include an element ID field 302, a length field 304, an element ID extension field 306, a control field 308, and an OMR content field 310, similar to the OMR format 300 of FIG. 3A.

However, in this example, the OMR content field 310 can include an OMN element 322 and an SR parameter set element 324, which may be an existing (e.g., pre-UHR) operating mode parameter. The OMN element 322 may include an element ID 322a, a length 322b, and an operating mode 322c. The SR parameter set element 324 may include an element ID 324a, a length 324b, an element ID extension 324c, an SR control 324d, a non-spatial reuse group (SRG) overlapping basic service set (OBSS) packet detect (PD) maximum offset 324e, an SRG OBSS PD minimum offset 324f, an SRG OBSS PD maximum offset 324g, an SRG BSS color bitmap 324h, and an SRG partial BSS identifier (BSSID) bitmap 324i. As defined in IEEE 802.11-2024, the SR parameter set element 324 can provide information needed by STAs when performing OBSS PD-based spatial reuse and Parameterized Spatial Reuse (PSR)-based SR.

In various examples, the existing (e.g., pre-UHR) operating mode or parameter for multi-AP scenarios may include a primary channel location, a BW, TX power, or SR Parameter Set values.

FIG. 3C illustrates an example OMR format 340 for new (e.g., UHR or post-UHR) operating mode parameters, according to an embodiment. For example, for some newer features considered in IEEE 802.11 TGbn, such as AP power save, NPCA, DSO, and preemption, the performance of these features may be affected by nearby APs and/or OBSS, and likewise the operation of these features may affect nearby APs and/or OBSS. According to embodiments, these features can therefore be adjusted to improve performance, coordination, and/or coexistence in multi-AP settings.

For example, an initiating AP (e.g., AP 202 of the examples of FIG. 2 above and FIGS. 4A-4B below) can request that a responding AP (e.g., AP 204 of the examples of FIGS. 2 and 4A-4B) change new (e.g., UHR or post-UHR) operating mode parameters, such as by enabling or disabling AP power save, or updating the AP power save modes or parameters, so as to improve performance. In another example, the initiating AP may request the responding AP to change new operating mode parameters such as by enabling or disabling NPCA or DSO, or updating the NPCA or DSO parameters, for example the location and/or BW of the NPCA primary channel. In a third example, the initiating AP can request the responding AP to change new parameters such as by enabling, disabling, and/or updating preemption or low latency operations.

Referring to FIG. 3C, the OMR format 340 for new (e.g., UHR) operating mode parameters can include an element ID field 302, a length field 304, an element ID extension field 306, a control field 308, and an OMR content field 310, similar to the OMR format 300 of FIG. 3A.

However, in this example, the OMR content field 310 can include an NPCA operation element 342 and a DPS operation element 344.

In an example, the new (e.g., UHR or post-UHR) operating mode or parameter for multi-AP scenarios may include AP power save, non-primary channel access (NPCA), Dynamic Sub-band Operation (DSO), or preemption and/or low latency operations.

FIG. 3D illustrates an example OMR format 370 for multi-AP coordination (e.g., UHR or post-UHR) operating mode parameters, according to an embodiment. For example, it has been proposed for IEEE 802.11 TGbn to define various multi-AP coordination schemes, such as co-SR, co-BF, co-TDMA, co-RTWT, and a common framework for multi-AP coordination procedures (e.g., discovery and agreement negotiation procedures). The OMR 370 can provide a framework for an initiating AP to request a responding AP to enable, disable, and/or update multi-AP coordination operating mode parameters.

In an example, depending on the network conditions and/or requirements, an initiating AP (e.g., AP 202 of the examples of FIG. 2 above and FIGS. 4A-4B below) can request that a responding AP (e.g., AP 204 of the examples of FIGS. 2 and 4A-4B) enable and/or disable certain multi-AP coordination schemes, and/or request that the responding AP update certain multi-AP coordination parameters. An OMR and/or response may be used for such purposes.

In various examples, the OMR and/or response can be used during an agreement negotiation procedure for multi-AP coordination, after the negotiation phase when there is a need to change certain multi-AP coordination modes and the associated parameters, or during network planning, testing, troubleshooting and/or maintenance phases. For example, the disclosed embodiments can reuse the AP-to-AP framework and/or the agreement negotiation procedure of the common framework for multi-AP coordination.

Referring to FIG. 3D, the OMR format 370 for multi-AP coordination (e.g., UHR or post-UHR) operating mode parameters can include an element ID field 302, a length field 304, an element ID extension field 306, a control field 308, and an OMR content field 310, similar to the OMR format 300 of FIG. 3A.

However, in this example, the OMR content field 310 can include a multi-AP operation element 372, a co-SR operation element 374, and a co-TDMA operation element 376.

In an example, the multi-AP coordination (e.g., UHR or post-UHR) operating mode or parameter may include a co-SR, a co-BF, a co-TDMA, a co-RTWT, a multi-AP coordination scheme, or a common framework for multi-AP coordination procedures.

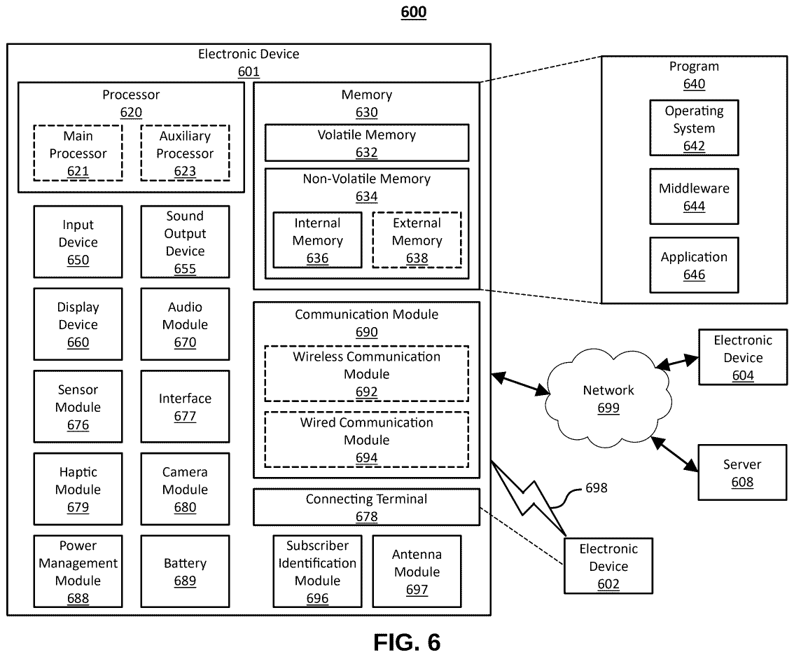

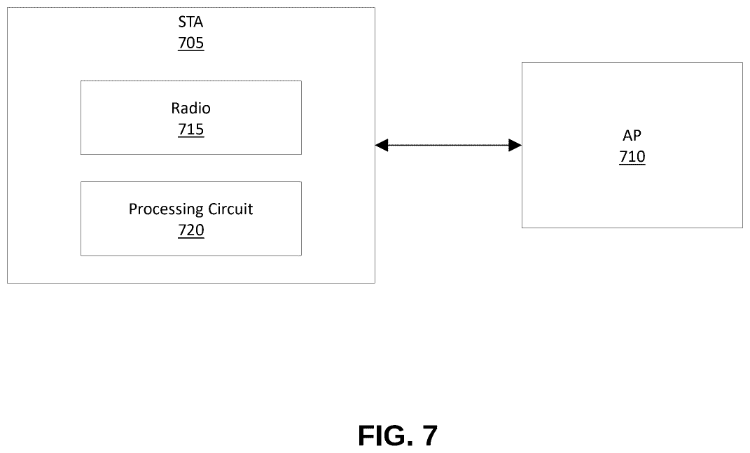

FIG. 4A is a communication flow diagram illustrating a method 400 to improve performance between APs 202 and 204, according to an embodiment. The method 400 may be performed by two APs 202 and 204 and a non-AP STA 212. In some embodiments, the APs 202 and 204 and non-AP STA 212 may belong to the same wireless network, such as a Wi-Fi network or WLAN. For example, the APs 202 and 204 may correspond to the APs 202 and 204 of FIG. 2, and the non-AP STA 212 may correspond to non-AP STA 212 of the example of FIG. 2. In another example, the respective APs 202 and 204 and/or non-AP STA 212 may correspond to the electronic devices 601, 602, and/or 604 of FIG. 6, and are not limited by the present disclosure. For example, the respective APs 202 and 204 and/or non-AP STA 212 may include a wireless transceiver (e.g., a radio transceiver), such as the wireless communication module 692 of FIG. 6, for communication via a wireless network, such as the network 699 of FIG. 6. In yet another example, the non-AP STA 212 may correspond to a mobile device and/or to another STA such as the STA 705 of FIG. 7, and is not limited by the present disclosure. The APs 202 and 204 may belong to a same BSS of the same wireless network.

In various examples, the wireless network may include any number of APs and/or non-AP STAs, and is not limited by the present disclosure. For example, the method 400 can be repeated for multiple APs and/or non-AP STAs.

In various embodiments, the method 400 (e.g., OMR and/or response) can be used during an agreement negotiation procedure for multi-AP coordination, after the negotiation phase when there is a need to change certain multi-AP coordination modes and the associated parameters, or during network planning, testing, troubleshooting and/or maintenance phases. In various embodiments, details and rules for how and when to utilize the method 400 (e.g., OMR and/or response) may vary. For example, in various embodiments an OMR can be sent between controller and/or controlled APs in controlled or centralized scenarios where APs are managed by one or more central controller, or from distributed and/or uncontrolled APs in uncontrolled or distributed scenarios where APs operate independently without a central manager. For example, an OMR may be transmitted from a controller AP to a controlled AP over the air. A controller AP may possess more information and have greater ability to control other APs. OMRs can also be transmitted from a controller AP to another controller AP, from a controlled AP to another controlled AP, from a controlled AP to a controller AP, and/or between distributed or uncontrolled APs.

Referring to FIG. 4A, the method 400 may begin with the AP 202 sending an OMR 402 to the AP 204. For example, the AP 202 may send the OMR 402 to the AP 204 in response to identifying sub-optimal network performance, such as the sub-optimal network performance or interference 100 of the example of FIG. 1. Alternatively or additionally, the AP 202 may have or expect to have certain changes (e.g., operating mode, network conditions, or throughput, latency, and/or QoS requirements) and may send the OMR 402 accordingly, e.g., for better throughput, latency, QoS, etc. In another example, AP 202 may want to make certain changes during network planning, testing, troubleshooting, or operating phases. The OMR 402 may be solicited or unsolicited, with or without a requirement of a response frame.

In some examples, the AP 202 can send the OMR 402 to the AP 204 via a wireless transceiver (e.g., a radio transceiver) and/or via the wireless network.

The OMR 402 may represent a request from AP 202 to change one or more operating mode or parameter of AP 204, for example so as to reduce interference or otherwise improve the network performance, as illustrated in FIG. 2. In an example, the OMR 402 may indicate a new operating mode or parameter and an expected start time. In various examples, AP 202 may have various reasons for transmitting OMR 402. For example, AP 202 may have or will have certain changes (e.g., operating mode, network conditions, or throughput, latency, and/or quality of service (QoS) requirements) and may request AP 204 to change its operating mode accordingly, e.g., for better throughput, latency, QoS, etc. AP 202 may also want to make certain changes during network planning, testing, troubleshooting, or operating phases.

As described in the examples of FIGS. 3B-3D above, OMR 402 can be used to request changes to pre-UHR parameters, new (e.g., UHR or post-UHR) features, and/or multi-AP coordination operating mode parameters. In some examples, certain operating mode parameters may affect neighboring APs and/or OBSS. Such operating mode parameters can be adjusted via OMR 402 to improve inter-AP or OBSS performance, for example, to avoid interference and improve coexistence. For example, AP 202 can request via OMR 402 that AP 204 change pre-UHR parameters, such as its primary channel location and/or BW, so as to reduce interference and thereby improve performance. In some examples, the performance of new (e.g., UHR or post-UHR) features may be affected by operations from nearby AP/OBSS, or the operations of the new features may affect the performance of nearby AP/OBSS. Such new (e.g., UHR or post-UHR) operating mode parameters can also be adjusted via OMR 402 to improve the performance or coexistence in multi-AP scenarios. For example, AP 202 can request via OMR 402 that AP 204 change UHR or post-UHR parameters, such as enabling or disabling AP power save or update AP power save modes/parameters, so as to reduce interference and thereby improve performance. Finally, in some examples, the OMR 402 can provide a framework for AP 202 to request that AP 204 enable, disable, and/or update multi-AP coordination operating mode parameters. For example, depending on the network conditions and/or requirements, AP 202 can request via OMR 402 that AP 204 enable and/or disable certain multi-AP coordination schemes, and/or request that AP 204 update certain multi-AP coordination parameters.

For example, the one or more operating mode or parameter may include one or more pre-UHR, UHR, or post-UHR operating mode or parameter. For example, an existing (e.g., pre-UHR) operating mode or parameter for multi-AP scenarios may include a primary channel location, a bandwidth (BW), transmit (TX) power, or SR Parameter Set values. In another example, a new (e.g., UHR or post-UHR) operating mode or parameter for multi-AP scenarios may include AP power save, non-primary channel access (NPCA), Dynamic Sub-band Operation (DSO), or preemption and/or low latency operations. In another example, a Multi-AP coordination (e.g., UHR or post-UHR) operating mode or parameter may include a co-SR, co-BF, co-TDMA, co-RTWT, a multi-AP coordination scheme, or a common framework for multi-AP coordination procedures. In another example, the operating mode or parameter may include a post-UHR operating mode or parameter to be defined in future generations of IEEE 802.11/Wi-Fi.

In various examples, the OMR 402 can correspond to the OMRs 300, 320, 340, and/or 370 of FIGS. 3A through 3D. For example, the OMR 402 may include a control field including control information and an OMR content field including content information. For example, the control information may include a request type, a mode, an ID, a token, or the like. The content information may include an OMN element, a multi-AP operation element, an operating mode parameter based on the control field, or the like. Moreover, as described above in the examples of FIGS. 3B-3D, the OMRs 320, 340, and 370 may respectively correspond to requests to change pre-UHR, UHR, or post-UHR operating modes or parameters.

The AP 204 can then send a response 404 to the AP 202. For example, the response 404 may include an acknowledgement that the AP 204 has changed the operating mode or parameter, or may include a refusal response. In an example, the response 404 may indicate that AP 204 has received the OMR 402, and may indicate whether or not AP 204 has accepted the requested operation mode change.

In an example, the response 404 may be received by AP 202 after an expected start time. If the response 404 indicates an acceptance of OMR 402 and the response 404 is sent after the expected start time, the response 404 may also be sent in accordance with the changed operating mode or parameter. Alternatively, in another the response 404 may be received before the expected start time, and the data 408 may be received after the expected start time. Since the AP 204 may have reasons of its own (e.g., QoS requirements) to run in a particular operating mode, in various embodiments the response 404 may include either an acceptance or refusal of the OMR 402.

For example, if the change to the operating mode or parameters requested by OMR 402 would not allow the AP 204 to meet its own QoS requirements, the response 404 may indicate a refusal of OMR 402. In some embodiments, if response 404 indicates a refusal, the method 400 may then end.

The AP 204 can then optionally send an OMN or OMI 406 to non-AP STA 212. According to various embodiments, the OMR 402 can be used as standalone or together with existing protocols such as OMN and/or OMI 406. For example, the OMN or OMI 406 can instruct the non-AP STA 212 to change an operating mode or parameter, such as the same operating mode or parameter previously specified by OMR 402. For example, the OMN or OMI 406 may indicate a new operating mode or parameter and an expected start time. In some embodiments, the AP 202 can instead send the OMN or OMI 406 to non-AP STA 212.

Next, the non-AP STA 212 can optionally send data 408 to AP 204. Alternatively or additionally, in embodiments in which the AP 202 sends the OMN or OMI 406 to non-AP STA 212, the non-AP STA 212 can optionally send data 408 to AP 202.

In some examples, if the response 404 indicates an acceptance of OMR 402, the non-AP STA 212 can optionally send the data 408 in accordance with the operating mode or parameter change requested by OMN or OMI 406. The non-AP STA 212 can optionally send the data 408, at or after the expected start time. The AP 204 may receive the data in accordance with the operating mode or parameter change, at or after the expected start time.

The method 400 can then end.

FIG. 4B is a communication flow diagram illustrating a method 450 to improve performance between APs 202 and 204, according to an embodiment. Like method 400 of FIG. 4A, the method 450 may be performed by two APs 202 and 204 and a non-AP STA 212. In some embodiments, the APs 202 and 204 and non-AP STA 212 may belong to the same wireless network, such as a Wi-Fi network or WLAN. For example, the APs 202 and 204 may correspond to the APs 202 and 204 of FIG. 2, and the non-AP STA 212 may correspond to non-AP STA 212 of the example of FIG. 2. In another example, the respective APs 202 and 204 and/or non-AP STA 212 may correspond to the electronic devices 601, 602, and/or 604 of FIG. 6, and are not limited by the present disclosure. In yet another example, the non-AP STA 212 may correspond to a mobile device and/or to another STA such as STA 705 of FIG. 7, and is not limited by the present disclosure. The APs 202 and 204 may belong to a same BSS of the same wireless network.

In various examples, the wireless network may include any number of APs and/or non-AP STAs, and is not limited by the present disclosure. For example, the method 450 can be repeated for multiple APs and/or non-AP STAs.

Referring to FIG. 4B, the method 450 may begin with the AP 202 sending an OMR 452 to the AP 204. For example, the AP 202 may send the OMR 452 to the AP 204 in response to identifying sub-optimal network performance. The AP 202 may send the OMR 452 to the AP 204 via a wireless transceiver (e.g., a radio transceiver) and/or via the wireless network. The OMR 452 may be solicited or unsolicited, with or without a requirement of a response frame.

As in the case of FIG. 4A, the OMR 452 may represent a request from AP 202 to change one or more operating mode or parameter of AP 204, for example so as to reduce interference or otherwise improve the network performance. In an example, the OMR 452 may indicate a new operating mode or parameter and an expected start time. In various examples, the OMR 452 can correspond to the OMRs 300, 320, 340, and/or 370 of FIGS. 3A through 3D. For example, the OMR 452 may include a control field including control information and an OMR content field including content information.

Next, the AP 204 can send an acknowledgement (e.g., ACK) 454 to the AP 202. For example, the acknowledgement 454 can acknowledge that the OMR 452 has been received.

In some examples, the ACK 454 and/or operating mode response 456 may provide options for explicit and implicit indications. For example, if the AP 202 receives the ACK 454 after transmitting OMR 452, but the AP 204 does not send the OMN or OMI 458, or any other related response frames, then the AP 202 may understand that the AP 204 has received and rejected the OMR 452. However, if the AP 204 decides to accept OMR 452, as described below, AP 204 may send an OMN or OMI 458 with the requested updated operating mode (or other mechanisms such as notify channel width and high throughput (HT), very high throughput (VHT), high efficiency (HE), extremely high throughput (EHT), ultra high reliability (UHR), or future generation operation elements).

The AP 204 can then send a response 456 to the AP 202. For example, the response 456 may include an acceptance (e.g., a confirmation that the AP 204 has changed the operating mode or parameter), or may include a refusal response. In particular, since the AP 204 may have reasons of its own (e.g., QoS requirements) to run in a particular operating mode, in various embodiments the response 456 may include either an acceptance or refusal of the OMR 452. In an example, the response 456 may indicate whether or not AP 204 has accepted the requested operation mode change. In another example, the response 456 may be received by AP 202 after an expected start time. If the response 456 indicates an acceptance of OMR 452 and the response 456 is sent after the expected start time, the response 456 may also be sent in accordance with the changed operating mode or parameter. In some embodiments, if response 456 indicates a refusal, the method 450 may then end.

Next, the AP 204 can optionally send an OMN or OMI 458 to non-AP STA 212. According to various embodiments, the OMR 452 can be used as standalone or together with existing protocols such as OMN and/or OMI 458. For example, the OMN or OMI 458 can instruct the non-AP STA 212 to change an operating mode or parameter, such as the same operating mode or parameter previously specified by OMR 452. For example, the OMN or OMI 458 may indicate a new operating mode or parameter and an expected start time. In some embodiments, the AP 202 can instead send the OMN or OMI 458 to non-AP STA 212.

Next, the non-AP STA 212 can send data 460 to AP 204. Alternatively or additionally, in embodiments in which the AP 202 sends the OMN or OMI 458 to non-AP STA 212, the non-AP STA 212 can optionally send data 460 to AP 202.

In some examples, if the response 456 indicates an acceptance of OMR 452, the non-AP STA 212 can send the data 460 in accordance with the operating mode or parameter change requested by OMN or OMI 458. The non-AP STA 212 can optionally send the data 460, at or after the expected start time. The AP 204 may receive the data in accordance with the operating mode or parameter change, at or after the expected start time.

The AP 204 can then send an acknowledgement (e.g., ACK) 462 to the non-AP STA 212. For example, the acknowledgement 462 can acknowledge that the data 460 has been received.

The method 450 can then end.

FIG. 5 is a flow diagram illustrating a method to improve performance between APs, according to an embodiment. The method 500 may be performed by initiating and responding APs and a non-AP STA, such as the APs 202 and 204 and non-AP STA 212 of the examples of FIGS. 2 and 4A-4B. In some embodiments, the initiating and responding APs and non-AP STA may belong to the same wireless network, such as a Wi-Fi network or WLAN. In another example, the initiating and responding APs and/or non-AP STA may correspond to the electronic devices 601, 602, and/or 604 of FIG. 6, and are not limited by the present disclosure. The initiating and responding APs and/or non-AP STA may include a wireless transceiver, such as the wireless communication module 692 of FIG. 6, for communication via a wireless network, such as the network 699 of FIG. 6. In another example, the non-AP STA may correspond to a mobile device and/or to another STA such as the STA 705 of FIG. 7, and is not limited by the present disclosure. In some examples, the initiating and responding APs may belong to a same BSS of the same wireless network. In various examples, the wireless network may include any number of APs and/or non-AP STAs, and is not limited by the present disclosure. For example, the method 500 can be repeated for multiple APs and/or non-AP STAs.

In various embodiments, the method 500 (e.g., OMR and/or response) can be used during an agreement negotiation procedure for multi-AP coordination, after the negotiation phase when there is a need to change certain multi-AP coordination modes and the associated parameters, or during network planning, testing, troubleshooting and/or maintenance phases. In various embodiments, details and rules for how and when to utilize the method 500 (e.g., sending the OMR and/or response) may vary. For example, in various embodiments an OMR can be sent from a controller AP to a controlled AP in controlled or centralized scenarios where APs are managed by one or more central controller, from distributed and/or uncontrolled APs in uncontrolled or distributed scenarios where APs operate independently without a central manager, from a controlled AP to another controlled AP, from a controlled AP to a controller AP, and/or between distributed or uncontrolled APs.

Referring to FIG. 5, the method 500 may begin with the initiating AP sending at 502 an OMR to the responding AP. For example, the initiating AP 202 send at 502 the OMR to the responding AP in response to identifying sub-optimal network performance, such as the sub-optimal network performance or interference 100 of the example of FIG. 1. In some examples, the initiating AP can send at 502 the OMR to the responding AP via a wireless transceiver (e.g., a radio transceiver) and/or via the wireless network.

As described above in the examples of FIGS. 1, 2, 3A-3D, and 4A-4B, the OMR may represent a request from AP 202 to change one or more operating mode or parameter of AP 204, for example so as to reduce interference or otherwise improve the network performance. In an example, the OMR may indicate a new operating mode or parameter and an expected start time. For example, the one or more operating mode or parameter may include one or more UHR, pre-UHR, or post-UHR operating mode or parameter.

In an embodiment, the operating mode or parameter can comprise a pre-UHR operating mode or parameter, the pre-UHR operating mode or parameter comprising one or more of: a primary channel location, a BW, TX power, or Spatial Reuse Parameter Set values. In another embodiment, the operating mode or parameter comprises a UHR operating mode or parameter, wherein the UHR operating mode or parameter comprises: a single-AP operating mode or parameter, comprising one or more of: AP power save, NPCA, DSO, preemption operations, or low latency operations; or an MAPC operating mode or parameter, comprising one or more of: co-SR, co-BF, Co-TDMA, Co-RTWT, an MAPC scheme, or a common framework for multi-AP coordination procedures. In another embodiment, the operating mode or parameter comprises a post-UHR operating mode or parameter to be defined in future generations of IEEE 802.11/Wi-Fi.

In various examples, the OMR sent at 502 can correspond to the OMRs 300, 320, 340, and/or 370 of FIGS. 3A through 3D. For example, the OMR may include a control field including control information and an OMR content field including content information. For example, the control information may include a request type, a mode, an ID, a token, or the like. The content information may include an OMN element, a multi-AP operation element, an operating mode parameter based on the control field, or the like.

Next, the responding AP can send at 504 a response to the initiating AP. For example, the response may include an acknowledgement that the responding AP has changed the operating mode or parameter, or may include a refusal response. In an example, the response may indicate that the responding AP has received the OMR, and may indicate whether or not the responding AP has accepted the requested operation mode change. In another example, the response may be received by the initiating AP after an expected start time.

Next, the responding AP can optionally send at 506 an OMN or OMI to the non-AP STA. For example, the OMN or OMI sent at 506 can instruct the non-AP STA to change an operating mode or parameter, such as the operating mode or parameter previously specified by the OMR. The OMN or OMI may indicate a new operating mode or parameter and an expected start time. In some embodiments, the initiating AP can instead send the OMN or OMI to the non-AP STA.

Next, the non-AP STA can optionally send at 508 data to the receiving AP. Alternatively or additionally, in embodiments in which the initiating AP sends at 506 the OMN or OMI to the non-AP STA, the non-AP STA can optionally send at 508 data to the initiating AP.

The non-AP STA may send at 508 the data in accordance with the operating mode or parameter change requested by the OMN or OMI. The non-AP STA can send at 508 the data at or after the expected start time. The receiving AP may receive the data in accordance with the operating mode or parameter change, at or after the expected start time.

The method 500 can then end.

FIG. 6 is a block diagram of an electronic device in a network environment 600, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

FIG. 7 shows a system including a STA 705 and an AP 710, in communication with each other. The STA 705 may include a radio 715 and a processing circuit (or a means for processing) 720, which may perform various methods disclosed herein, e.g., the method illustrated in FIG. 1. For example, the processing circuit 720 may receive, via the radio 715, transmissions from the network node (AP) 710, and the processing circuit 720 may transmit, via the radio 715, signals to the AP 710.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed between Access Points (APs), the method comprising:
sending, by an initiating AP to a responding AP, an operating mode request (OMR) to change an operating mode or parameter of the responding AP; and
receiving, by the initiating AP from the responding AP, a response to the OMR, wherein the response comprises: an acknowledgement of changing the operating mode or parameter, or a refusal response.

2. The method of claim 1, wherein the operating mode or parameter comprises an Ultra High Reliability (UHR), pre-UHR, or post-UHR operating mode or parameter.

3. The method of claim 2, wherein:
the operating mode or parameter comprises the pre-UHR operating mode or parameter, the pre-UHR operating mode or parameter comprising one or more of: a primary channel location, a bandwidth (BW), transmit (TX) power, or Spatial Reuse Parameter Set values;
the operating mode or parameter comprises the UHR operating mode or parameter, wherein the UHR operating mode or parameter comprises:
a single-AP operating mode or parameter, comprising one or more of: AP power save, non-primary channel access (NPCA), Dynamic Sub-band Operation (DSO), preemption operations, or low latency operations; or
a multi-AP coordination (MAPC) operating mode or parameter, comprising one or more of: coordinated spatial reuse (co-SR), coordinated beamforming (co-BF), Coordinated Time Division Multiple Access (Co-TDMA), Coordinated Restricted Target Wake Time (Co-RTWT), a multi-AP coordination scheme, or a common framework for multi-AP coordination procedures; or
the operating mode or parameter comprises the post-UHR operating mode or parameter.

4. The method of claim 1, wherein the initiating AP and responding AP belong to one or more of:
a same wireless network;
a same basic service set (BSS); or
a same wireless local area network (WLAN).

5. The method of claim 1, wherein the method improves performance between APs by reducing interference between the initiating AP and the responding AP.

6. The method of claim 1, further comprising sending, to a non-AP station (STA), an operating mode notification (OMN) or operating mode indication (OMI) instructing the non-AP STA to change the operating mode or parameter.

7. The method of claim 6, further comprising transmitting or receiving data, to or from the non-AP STA, in accordance with the instructions to change the operating mode or parameter.

8. The method of claim 1, wherein the OMR comprises:
a control field including control information; and
an OMR content field including content information.

9. The method of claim 1, wherein the OMR comprises an expected start time.

10. A method performed by a responding access point (AP), the method comprising:
receiving, from an initiating AP, an operating mode request (OMR) to change an operating mode or parameter of the responding AP;
determining to accept the OMR; and
responsive to determining to accept the OMR:
changing the operating mode or parameter; and
sending, to the initiating AP, a response to the OMR comprising an acknowledgement of the changing the operating mode or parameter;
wherein the responding AP is configured to, responsive to determining to refuse the OMR, send a refusal response to the initiating AP.

11. The method of claim 10, wherein:
the operating mode or parameter comprises a pre-Ultra High Reliability (pre-UHR) operating mode or parameter, the pre-UHR operating mode or parameter comprising one or more of: a primary channel location, a bandwidth (BW), transmit (TX) power, or Spatial Reuse Parameter Set values;
the operating mode or parameter comprises an Ultra High Reliability (UHR) operating mode or parameter, wherein the UHR operating mode or parameter comprises:
a single-AP operating mode or parameter, comprising one or more of: AP power save, non-primary channel access (NPCA), Dynamic Sub-band Operation (DSO), preemption operations, or low latency operations; or
a multi-AP coordination (MAPC) operating mode or parameter, comprising one or more of: coordinated spatial reuse (co-SR), coordinated beamforming (co-BF), Coordinated Time Division Multiple Access (Co-TDMA), Coordinated Restricted Target Wake Time (Co-RTWT), a multi-AP coordination scheme, or a common framework for multi-AP coordination procedures; or
the operating mode or parameter comprises a post-UHR operating mode or parameter.

12. The method of claim 10, wherein the initiating AP and responding AP belong to one or more of:
a same wireless network;
a same basic service set (BSS); or
a same wireless local area network (WLAN).

13. The method of claim 10, wherein the method improves performance between APs by reducing interference between the initiating AP and the responding AP.

14. The method of claim 10, wherein receiving the request is via a wireless transceiver and/or via a radio transceiver.

15. The method of claim 10, further comprising, responsive to determining to accept the OMR, sending, to a non-AP station (STA), an operating mode notification (OMN) or operating mode indication (OMI) instructing the non-AP STA to change the operating mode or parameter.

16. An initiating Access Point (AP), comprising:
a wireless transceiver; and
a processor configured to:
transmit, via the wireless transceiver and to a responding AP, an operating mode request (OMR) to change an operating mode or parameter of the responding AP; and
receive, from the responding AP, a response to the OMR, wherein the response comprises: an acknowledgement of changing the operating mode or parameter, or a refusal response.

17. The initiating AP of claim 16, wherein:
the operating mode or parameter comprises a pre-Ultra High Reliability (pre-UHR) operating mode or parameter, the pre-UHR operating mode or parameter comprising one or more of: a primary channel location, a bandwidth (BW), transmit (TX) power, or Spatial Reuse Parameter Set values;
the operating mode or parameter comprises an Ultra High Reliability (UHR) operating mode or parameter, wherein the UHR operating mode or parameter comprises:
a single-AP operating mode or parameter, comprising one or more of: AP power save, non-primary channel access (NPCA), Dynamic Sub-band Operation (DSO), preemption operations, or low latency operations; or
a multi-AP coordination (MAPC) operating mode or parameter, comprising one or more of: coordinated spatial reuse (co-SR), coordinated beamforming (co-BF), Coordinated Time Division Multiple Access (Co-TDMA), Coordinated Restricted Target Wake Time (Co-RTWT), a multi-AP coordination scheme, or a common framework for multi-AP coordination procedures; or
the operating mode or parameter comprises a post-UHR operating mode or parameter.

18. The initiating AP of claim 16, wherein the OMR comprises:
a control field including one or more of:
a request type;
a mode;
an identifier (ID);
a token; or
other control information; and
an OMR content field including one or more of:
an operating mode notification (OMN) element;
a multi-AP operation element;
an operating mode parameter based on the control field; or
other content information.

19. The initiating AP of claim 16, wherein the initiating AP is further configured to send, to a non-AP station (STA), an operating mode notification (OMN) or operating mode indication (OMI) instructing the non-AP STA to change the operating mode or parameter.

20. The initiating AP of claim 19, wherein the initiating AP is further configured to transmit or receive data, to or from the non-AP STA, in accordance with the instructions to change the operating mode or parameter.
